(19) United States
(12) Patent Application Publication
(10) Pub. No.: US 2008/0283494 A1
(43) Pub. Date: Nov. 20, 2008

(54) METHOD OF MANUFACTURING THERMAL INKJET PRINTHEAD

(75) Inventors: Il-woo Kim, Seoul (KR); Jin-wook Lee, Seoul (KR); Byung-ha Park, Suwon-si (KR); Myong-jong Kwon, Suwon-si (KR); Kyong-il Kim, Yongin-si (KR); Hye-young Min, Yongin-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/874,551

(22) Filed: Oct. 18, 2007

(30) Foreign Application Priority Data
May 17, 2007 (KR) 2007-48245

(51) Int. Cl. G11B 5/127

(52) U.S. Cl. 216/27

(57) ABSTRACT

A method of manufacturing a thermal inkjet printhead. The method includes forming on a substrate a chamber layer having an ink chamber, forming a sacrificial layer on the chamber layer wherein the sacrificial layer fills the ink chamber, and planarizing a top surface of the sacrificial layer and of the chamber layer using a primary Chemical Mechanical Polishing (CMP) process until the sacrificial layer and the chamber layer attain a desired height, wherein a slurry is used in the primary CMP process that includes polishing particles having an average particle size of 500 nm˜2 μm.

### CROSS-REFERENCE TO RELATED APPLICATIONS

This application claims priority from Korean Patent Application No. 10-2007-0048245, filed on May 17, 2007, in the Korean Intellectual Property Office, the disclosure of which is incorporated herein in its entirety by reference.

### BACKGROUND OF THE INVENTION

1. Field of the Invention

The present general inventive concept relates to an inkjet printhead, and more particularly, to a method of manufacturing a thermal inkjet printhead.

2. Description of the Related Art

Generally, an inkjet printhead is an apparatus that ejects fine droplets of a printing ink on a desired area of a print medium, such as printer paper, in order to print predetermined images, including color images. The inkjet printhead can be classified into two types according to the ejection mechanism of ink droplets. One type is a thermal inkjet printhead that ejects ink droplets by an expansion force of bubbles which are produced in the ink by a thermal source, and the other type is a piezoelectric inkjet printhead that ejects ink droplets by applying a pressure to the ink produced by deformation of a piezoelectric element.

The ejection mechanism of ink droplets from a conventional thermal inkjet printhead will now be described in more detail. When a pulse current is applied to a heater formed of a resistive heating material, heat is generated from the heater, and ink adjacent to the heater is immediately heated to about 300° C., thereby producing bubbles by boiling the ink. The bubbles expand and pressurize ink filled in an ink chamber. As a result, ink positioned near a nozzle is ejected in the form of droplets from the ink chamber through the nozzle.

FIG. 1 is a partial plan view illustrating a conventional thermal inkjet printhead, and FIG. 2 is a sectional view taken along a line II-II′ of FIG. 1. Referring to FIGS. 1 and 2, an inkjet printhead includes a substrate 10 on which a plurality of material layers are disposed, a chamber layer 20 disposed on the substrate 10, and a nozzle layer 30 disposed on the chamber layer 20. A plurality of ink chambers 22 are formed in the chamber layer 20, and a plurality of nozzles 32 through which ink is ejected are formed in the nozzle layer 30. An ink feed hole 11 to supply ink to the ink chambers 22 is formed through the substrate 10. A plurality of restrictors 24 are formed in the chamber layer 20 to connect the ink chambers 22 and the ink feed hole 11.

Meanwhile, an insulating layer 12 to insulate the substrate 10 from a plurality of heaters 14 is formed on the substrate 10. The heaters 14 are formed on the insulating layer 12. Electrodes 16 are formed on the heaters 14. A passivation layer 18 is formed to cover the heaters 14 and the electrodes 16 on the insulating layer 12. Anti-cavitation layers 19 are formed on the passivation layer 18 to protect the heaters 14 from a cavitation force generated by the collapse of the bubbles.

In order to manufacture the above inkjet printhead, a sacrificial layer 25, described in detail below, is formed to fill the ink chambers 22 formed in the chamber layer 20, and the top surface of the sacrificial layer is then planarized using, generally, a Chemical Mechanical Polishing (CMP) process. FIGS. 3A through 3E schematically illustrate a conventional CMP process used to manufacture an inkjet printhead. FIGS. 3A through 3E are sectional views taken along a line III-III′ of FIG. 1, and heaters 14, electrodes 16, passivation layer 18 and anti-captivation layer 19 (refer to FIG. 2) are not shown for the sake of convenience.

Referring to FIG. 3A, a chamber layer 20 having an ink chamber 22 therein is formed on a substrate 10 on which a heater, an electrode, etc., as described above, are formed. For example, the chamber layer 20 may be formed of a photosensitive epoxy resin. Then, as illustrated in FIG. 3B, a sacrificial layer 25 is formed on the chamber layer 20 in such a way that the sacrificial layer 25 fills the ink chamber 22. For example, the sacrificial layer 25 may be formed of photoresist material. A top surface of the sacrificial layer 25 formed on the chamber layer 20 is planarized using a CMP process. In detail, referring to FIG. 3C, a slurry (not shown) is coated on the top surface of the sacrificial layer 25, and the top surface of the sacrificial layer 25 is then polished by a polisher 50. In this example, the slurry includes small polishing particles having an average particle size of about 100 nm. In FIG. 3C, a reference numeral 51 refers to a polishing pad contacting with the top surface of the sacrificial layer 25 to apply a predetermined pressure to the top surface of the sacrificial layer 25, and a reference numeral 52 refers to a platen to rotate the polishing pad 51. While the polishing process is performed to reduce sacrificial layer 25, the top surface of the chamber layer 20 becomes exposed to polishing pad 51, as illustrated in FIG. 3D. The chamber layer 20 is formed of a material having a greater hardness than the photoresist material which forms the sacrificial layer 25, i.e., a photosensitive epoxy resin. Thus, as the polishing process is continued, the chamber layer 20 is barely reduced, whereas the sacrificial layer 25 is continuously polished and reduced, thereby causing a dishing phenomenon in which a height of the sacrificial layer 25 is lower than a height of the chamber layer 20, as illustrated in FIG. 3E. When the dishing phenomenon occurs, the ink chamber 22 cannot be formed to a desired constant height, which thereby degrades the ink ejection characteristics of an inkjet printhead. FIG. 4 is an image illustrating a profile of an inkjet printhead manufactured using a conventional CMP process having nozzle 32 formed over ink chamber 22. Referring to FIG. 4, a height of an ink chamber 22 is not uniform due to a dishing phenomenon. In addition, when the chamber layer 20 has an indented top surface, it is difficult to planarize the top surface of the chamber layer 20 using a conventional CMP process, as described above.

### SUMMARY OF THE INVENTION

The present general inventive concept provides a method of manufacturing a thermal inkjet printhead using a Chemical Mechanical Polishing (CMP) process capable of enhancing ink ejection characteristics.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing a method of manufacturing a thermal inkjet printhead, the method including forming on a substrate a chamber layer having an ink chamber, forming a sacrificial layer on the chamber layer wherein the sacrificial layer fills the ink chamber, and planarizing a top surface of the sacrificial layer and a top surface of the chamber layer using a primary CMP process until the sacrificial layer and the chamber layer attain a desired height, wherein a slurry is used in the primary CMP process and includes polishing particles having an average particle size of 500 nm ˜2 μm.

The polishing particles may be made of silica or alumina.

The polishing particles may have pH of 2.5˜11.

A polishing pad may be used in the primary CMP process and may be rotated while exerting a pressure of 5˜45 kPa to a top surface of the sacrificial layer.

A surface hardness of the polishing pad may be 70 or less, as measured in Shore D hardness.

The chamber layer may be formed of a material having a greater hardness than the sacrificial layer.

The chamber layer and the sacrificial layer may be formed, respectively, of a photosensitive epoxy resin and a photoresist material.

In the formation of the chamber layer, the photosensitive epoxy resin may be coated on the substrate using a spin coating process and a pattern may be formed thereon using a photolithography process.

In the formation of the sacrificial layer, the photoresist material may be coated on the chamber layer using a spin coating process.

The method may include planarizing the top surface of the chamber layer and of the sacrificial layer using a secondary CMP process, after performing the primary CMP process.

A slurry may be used in the secondary CMP process which may include polishing particles having an average particle size of 50˜500 nm.

The foregoing and/or other aspects and utilities of the present general inventive concept may be achieved by providing an alternative method of manufacturing a thermal inkjet printhead, the method including forming an insulating layer on a substrate sequentially forming, on the insulating layer, a heater to heat ink and an electrode to apply current to the heater, forming on the insulating layer a chamber layer having an ink chamber, forming in the insulating layer a trench through which the substrate is exposed, forming a sacrificial layer on the chamber layer wherein the sacrificial layer fills the ink chamber and the trench, planarizing a top surface of the sacrificial layer and of the chamber layer using a primary CMP process until the sacrificial layer and the chamber layer have attained a desired height, forming on the planarized sacrificial layer and chamber layer a nozzle layer having a nozzle, etching a bottom surface of the substrate to form an ink feed hole to connect with the trench, and removing the sacrificial layer, wherein a slurry is used in the primary CMP process which includes polishing particles having an average particle size of 500 nm˜2 μm.

A slurry used in the secondary CMP process may include polishing particles having an average particle size of 50˜500 nm.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a schematic plan view illustrating a conventional thermal inkjet printhead;

FIG. 2 is a sectional view taken along a line II-II′ of FIG. 1;

FIGS. 3A through 3E illustrate a conventional Chemical Mechanical Polishing (CMP) process used to manufacture an inkjet printhead as illustrated in FIG. 1;

FIG. 4 is an image illustrating a profile of an inkjet printhead manufactured using a conventional CMP process.

FIGS. 5 through 10 illustrate processes to manufacture a thermal inkjet printhead according to an embodiment of the present general inventive concept;

FIGS. 11A through 11H are views illustrating a CMP process used in a method of manufacturing a inkjet printhead according to an embodiment of the present general inventive concept;

FIGS. 12A and 12B are respectively a plan view and a side view of an apparatus performing a CMP process used in a method of manufacturing a inkjet printhead according to an embodiment of the present general inventive concept; and

FIG. 13 is an image illustrates a profile of an inkjet printhead manufactured using a method according to an embodiment of the present general inventive concept.

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

In the drawings, sizes or thicknesses of constitutional elements may be exaggerated for the sake of clarity of illustration. When a layer is referred to as being “on” a substrate or another layer, it can be disposed directly on the substrate or the other layer or an intervening layer(s) may also be present. Each constitutional element of an inkjet printhead may be formed of a material different from the exemplified material. Stacking and formation methods of material layers are provided only for the purpose of illustration, and thus, various methods different from exemplified methods can be used. Moreover, in a method of manufacturing an inkjet printhead, a sequence of processes may be changed in some cases.

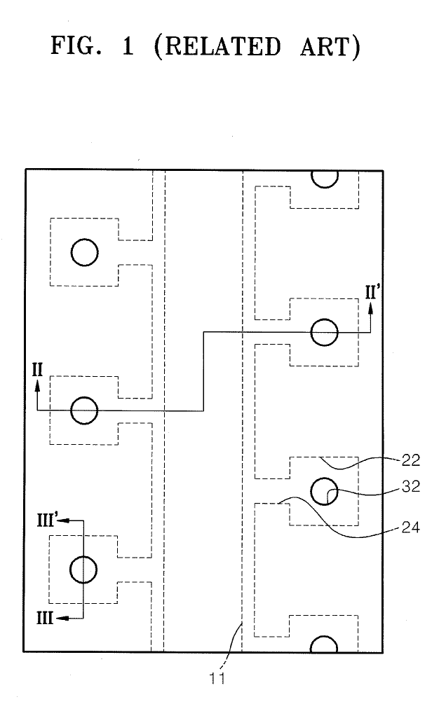

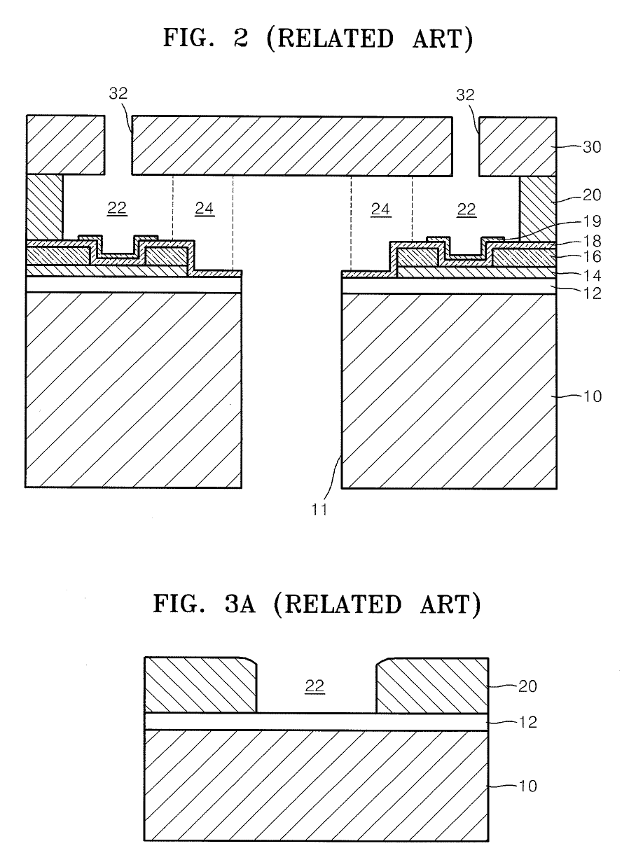

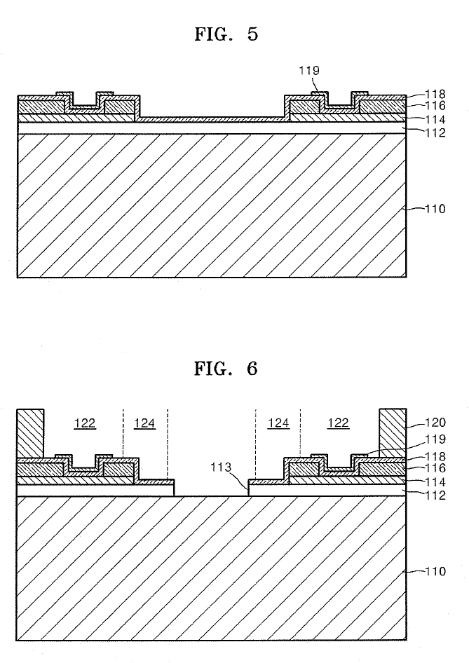

FIGS. 5 through 10 are views illustrating a method of manufacturing a thermal inkjet printhead according to an embodiment of the present general inventive concept. The views illustrated in FIGS. 5 through 10 are taken along a line II-II′ of FIG. 1.

Referring to FIG. 5, a substrate 110 is illustrated. An insulating layer 112 is formed on the substrate 110. The substrate 110 may be a silicone substrate. The insulating layer 112 is a layer to insulate the substrate 110 from heaters 114 as will be described later, and may be formed of, for example, silicon oxide. Then, the heaters 114 are formed on the insulating layer 112 to heat ink in order to produce bubbles in the ink. The heaters 114 may be formed by depositing a heating resistor, such as tantalum-aluminum alloy, tantalum nitride, titanium nitride, or tungsten silicide, on the insulating layer 112 and then forming a pattern on the deposited heating resistor. Electrodes 116 are formed on the heaters 114 to apply current to the heaters 114. The electrodes 116 may be formed by depositing a metal having good electroconductivity, such as aluminum, aluminum alloy, gold, or silver, on the heaters 114, and then forming a pattern on the deposited metal.

In an embodiment of the present general inventive concept, a passivation layer 118 may be further formed on the insulating layer 112 to cover the heaters 114 and the electrodes 116. The passivation layer 118 prevents oxidation or corrosion of the heaters 114 and the electrodes 116 that may be caused when the heaters 114 and the electrodes 116 come into contact with ink, and thus, may be formed of, for example, silicon nitride or silicon oxide. Anti-cavitation layers 119 may be further formed on the passivation layer 118 disposed on the heaters 114. The anti-cavitation layers 119 protect the heaters 114 from a cavitation force exerted by the collapse of bubbles in the ink, and thus, may be formed of, for example, tantalum.

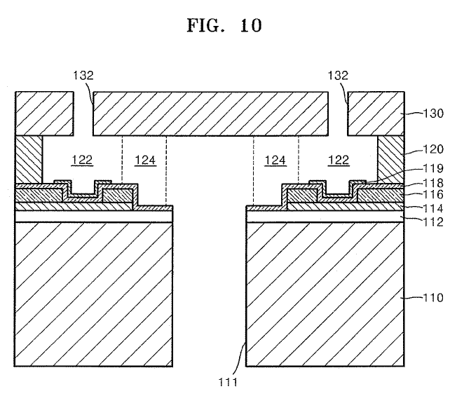

Referring to FIG. 6, a chamber layer 120 having ink chambers 122 disposed therein is formed on the passivation layer 118. The chamber layer 120 may be formed by coating a predetermined material (for example, a photosensitive epoxy resin) to a predetermined thickness on the entire top surface of the resultant structure of FIG. 5 and forming a pattern on the coated material using a photolithography process. For example, the photosensitive epoxy resin may be coated by a spin coating process. As a result, the ink chambers 122 which are filled with ink to be ejected are formed in the chamber layer 120. Here, the ink chambers 122 may be disposed over the heaters 114. In this procedure, restrictors 124, which are passages connecting the ink chambers 122 and an ink feed hole 111 (refer to FIG. 10), as will be described later, may be further formed in the chamber layer 120. Then, the passivation layer 118 and the insulating layer 112 are sequentially etched to form a trench 113 through which a top surface of the substrate 110 is exposed. The trench 113 is connected to an ink feed hole 111 (refer to FIG. 10), as will be described later, and may be formed over the ink feed hole 111.

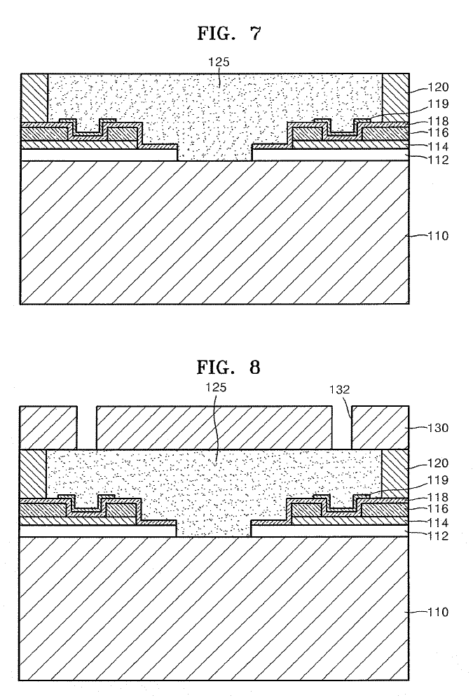

Referring to FIG. 7, a sacrificial layer 125 is formed on the chamber layer 120 in such a way that the sacrificial layer 125 fills in the trench 113, the ink chambers 122, and the restrictors 124. Then, top surfaces of the sacrificial layer 125 and the chamber layer 120 are planarized using a Chemical Mechanical Polishing (CMP) process.

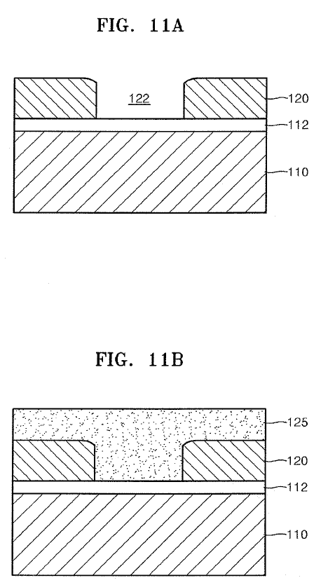

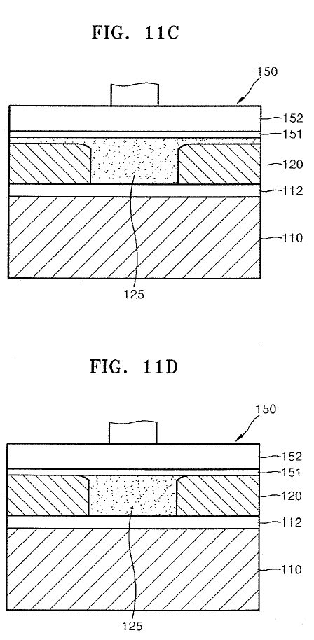

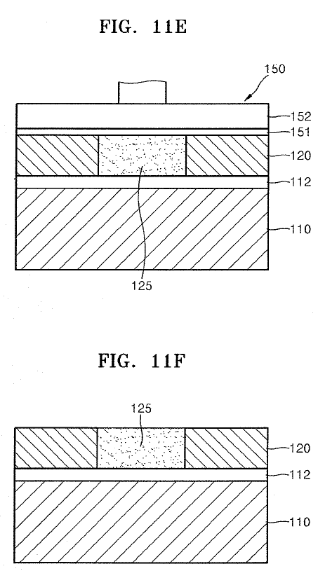

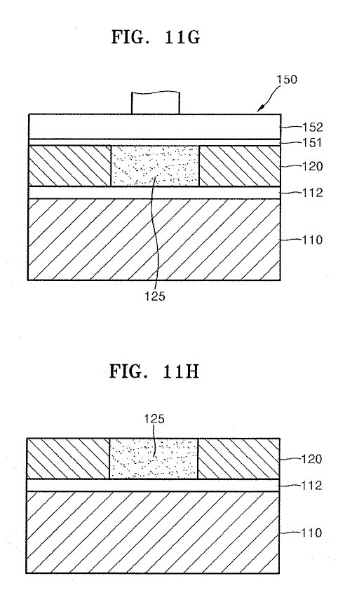

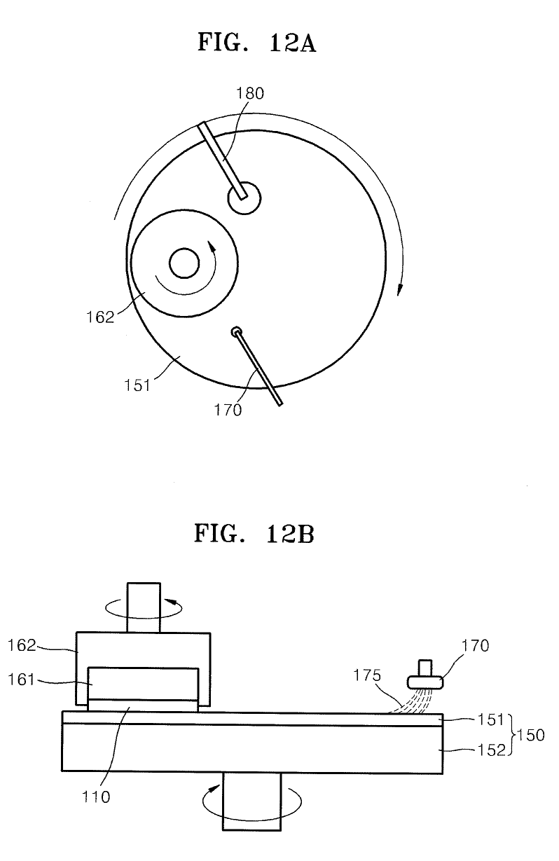

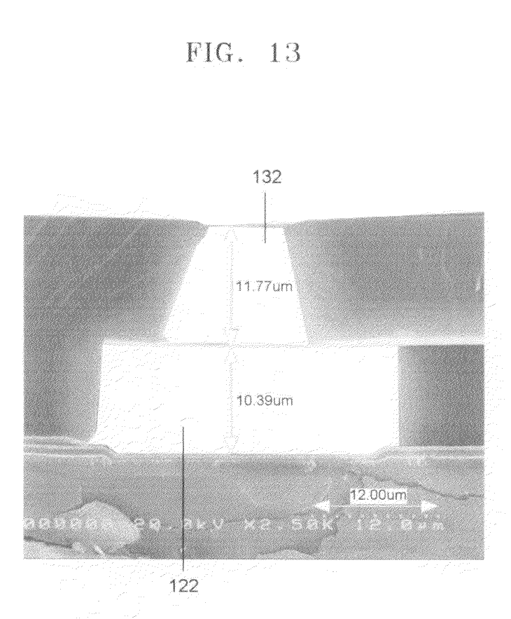

FIGS. 11A through 11H are views illustrating a CMP process used in a method of manufacturing an inkjet printhead according to an embodiment of the present general inventive concept. FIGS. 12A and 12B are, respectively, a plan view and a side view of an apparatus performing a CMP process used in a method of manufacturing an inkjet printhead according to an embodiment of the present general inventive concept.

Referring to FIGS. 12A and 12B, a substrate 110 having disposed thereon a chamber layer (not shown) and a sacrificial layer (not shown) is attached to a holder 161. The holder 161 is rotatably supported by a carrier 162. A polisher 150 to polish the sacrificial layer and the chamber layer includes a polishing pad 151 to rotatably pressurize the substrate 110 and a platen 152 to rotate the polishing pad 151. A predetermined amount of slurry 175 is periodically supplied to a surface of the polishing pad 151 from a slurry supply unit 170, and the condition of a polishing surface of the polishing pad 151 is constantly maintained by a conditioner 180.

In the polishing process, the slurry 175 supplied to a surface of the polishing pad 151 from the slurry supply unit 170 is moved toward the substrate 110 by rotation of the polishing pad 151. During this time, the substrate 110 is also rotated while exerting a predetermined amount of pressure to the polishing pad 151. During this polishing procedure, chemical polishing is performed by a solution contained in the slurry 175, and mechanical polishing is performed by a frictional force produced between the substrate 110 and the polishing pad 151 due to rotation and pressurization. For the mechanical polishing, the slurry 175 includes polishing particles having a predetermined particle size to optimize the polishing process.

Hereinafter, a CMP process according to an embodiment of the present general inventive concept will be described in detail with reference to FIGS. 11A through 11H. Views illustrated in FIGS. 11A through 11H are taken along a line III-III′ of FIG. 1. For the sake of convenience, the heater, electrode, etc. are not shown.

Referring to FIG. 11A, a chamber layer 120 having an ink chamber 122 therein is formed on a substrate 110. The formation of the chamber layer 120 is as described above. Referring to FIG. 11B, a sacrificial layer 125 is formed on the chamber layer 120 in such a way to fill in a trench (not shown), the ink chamber 122, and a restrictor (not shown). In detail, the sacrificial layer 125 may be formed by coating a predetermined material to a predetermined thickness on the entire surface of the resultant structure of FIG. 11A using, for example, a spin coating process. Here, the sacrificial layer 125 may be formed of a material having less hardness than a material forming the chamber layer 120. For example, the sacrificial layer 125 may be formed of photoresist material, but is not limited thereto.

Next, referring to FIG. 11C, a primary CMP process is performed on top surfaces of the sacrificial layer 125 and the chamber layer 120. In FIG. 11C, reference numerals 150, 151, and 152 refer to a polisher, a polishing pad, and a platen, respectively, as previously described and as illustrated in FIGS. 12A and 12B.

In the primary CMP process performed in an embodiment of the present general inventive concept, a slurry 175 (refer to FIG. 12B) having relatively large polishing particles having an average particle size of about 500 nm ˜2 μm is used. The polishing particles may be made of silica or alumina and may have a pH of 2.5˜11. The polishing pad 151 used in the primary CMP process can be rotated while exerting a pressure of about 5 to 45 kPa on a surface of the sacrificial layer 125. Here, the surface hardness of the polishing pad 151 may be about 70 or less, as measured in Shore D hardness. For example, the polishing pad 151 may be made of a textile material or rubber.

In an embodiment of the present general inventive concept, the slurry 175 may be supplied at a rate of about 5˜100 cc per minute, and a carrier 162 (refer to FIGS. 12A and 12B) and the platen 152 may be rotated at a rate of about 10˜200 rpm. However, the supply rate of the slurry 175 and the rotation rate of the carrier 162 and the platen 152 can be changed.

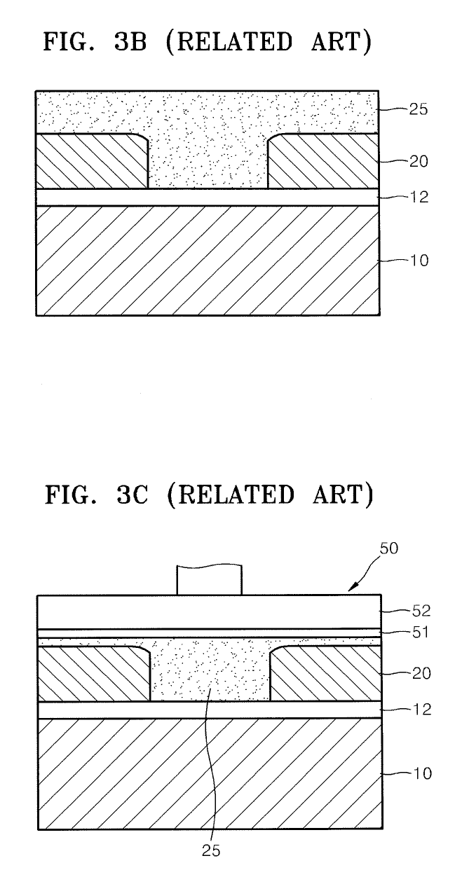

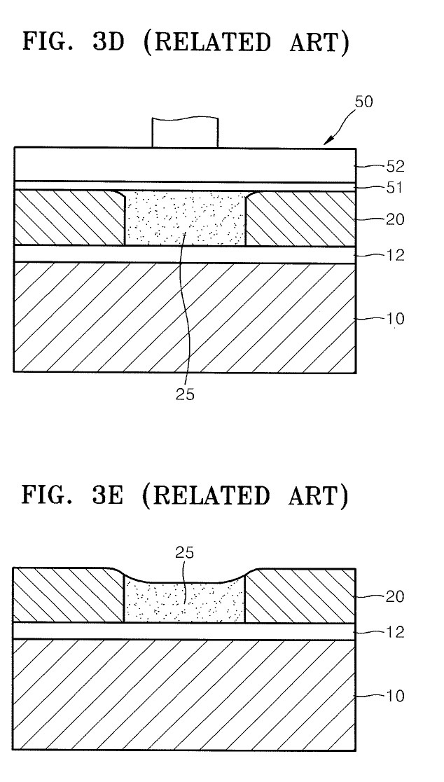

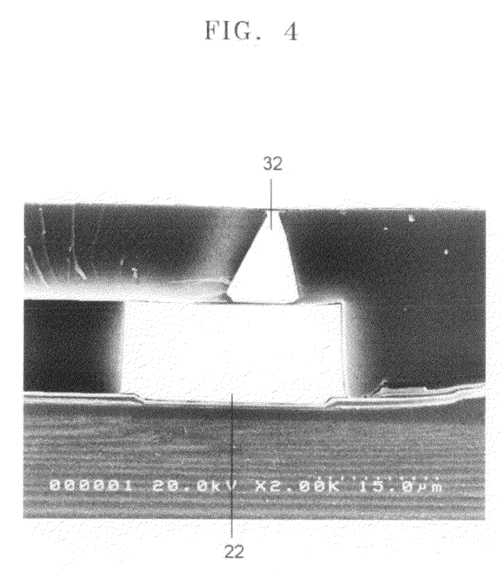

When the primary CMP process is performed as described above, a top surface of the sacrificial layer 125 is polished and reduced and a top surface of the chamber layer 120 is likewise polished and reduced to expose chamber layer 120 to the platen 152, as illustrated in FIG. 11D. As the primary CMP process is continued, the chamber layer 120 and the sacrificial layer 125 are polished and reduced at almost the same rates, as illustrated in FIG. 11E. A slurry used in a conventional CMP process includes polishing particles having a relatively small particle size, which is different than the current method. Thus, as the polishing process using the conventional CMP process is continued after a top surface of a chamber layer is exposed, the chamber layer 20 (refer to FIG. 3E) formed of a material having a greater hardness than a material forming the sacrificial layer 25 is barely reduced, but the sacrificial layer is reduced further. However, in an embodiment of the present general inventive concept, since a slurry 175 includes relatively large polishing particles having an average particle size of about 500 nm˜2 μm is used, even when the polishing process is continued after a top surface of the chamber layer 120 is exposed, the chamber layer 120 and the sacrificial layer 125 are thereafter polished and reduced at almost the same rates. Therefore, the chamber layer 120 and the sacrificial layer 125 can be formed to be substantially the same height. The primary CMP process is continued until the chamber layer 120 and the sacrificial layer 125 have achieved the desired height. FIG. 11F illustrates the chamber layer 120 and the sacrificial layer 125 after the primary CMP process of an embodiment of the present general inventive concept is completed. As illustrated in FIG. 11F, since the polishing rate of the chamber layer 120 is substantially the same as that of the sacrificial layer 125, the chamber layer 120 and the sacrificial layer 125 can be formed to have substantially the same height after the primary CMP process is completed.

After the chamber layer 120 and the sacrificial layer 125 are planarized using the above-described primary CMP process, the formation of a nozzle layer 130 (refer to FIG. 8), to be described below, can be attained.

In an embodiment of the present general inventive concept, after performing the above-described primary CMP process, the chamber layer 120 and the sacrificial layer 125 may be further planarized using a secondary CMP process as illustrated in FIG. 11G. In detail, since a slurry 175 (refer to FIG. 12B) which includes polishing particles having a relatively large particle size is used in the above-described primary CMP process, one or mores scratches may be formed on a surface of the sacrificial layer 125 after the primary CMP process is completed. Thus, the secondary CMP process serves to remove any scratch formed on a surface of the sacrificial layer 125 and to enhance the degree of planarity of the chamber layer 120 and the sacrificial layer 125.

In the secondary CMP process performed in an embodiment of the present general inventive concept, a slurry 175 which includes relatively small polishing particles having an average particle size of about 50˜500 nm is used. The polishing particles may be made of silica or alumina and may have pH of 2.5˜11. Similar to the above-described primary CMP process, a polishing pad 151 used in the secondary CMP process can be rotated while exerting a pressure of about 5 to 45 kPa to a surface of the sacrificial layer 125. Here, a surface hardness of the polishing pad 151 may be about 70 or less, as measured in Shore D hardness. For example, the polishing pad 151 may be made of a textile material or rubber. Meanwhile, the slurry 175 may be supplied at a rate of about 5˜100 cc per minute, and a carrier 162 (refer to FIGS. 12A and 12B) and a platen 152 may be rotated at a rate of about 10˜200 rpm. However, the supply rate of the slurry 175 and the rotation rate of the carrier 162 and the platen 152 can be changed.

As described above, when the chamber layer 120 and the sacrificial layer 125, which have been pretreated with the primary CMP process, are subjected to the secondary CMP process using a slurry 175 which includes relatively small polishing particles, a scratch formed on a surface of the sacrificial layer 125 during the primary CMP process can be removed, and at the same time, the degree of planarity of the chamber layer 120 and the sacrificial layer 125 can be further enhanced. FIG. 11H illustrates the chamber layer 120 and the sacrificial layer 125 after the secondary CMP process is completed.

Referring to FIG. 8, a nozzle layer 130 having nozzles 132 disposed therein is formed on the chamber layer 120 and the sacrificial layer 125 that have been planarized as described above. The nozzle layer 130 may be formed by coating a predetermined material, for example, a photosensitive epoxy resin, on the chamber layer 120 and the sacrificial layer 125 and by forming a pattern on the coated material using a photolithography process. As a result, the nozzles 132, through which a top surface of the sacrificial layer 125 is exposed, are formed in the nozzle layer 130. In an embodiment, the nozzles 132 may be disposed over the ink chambers 122 (refer to FIG. 6).

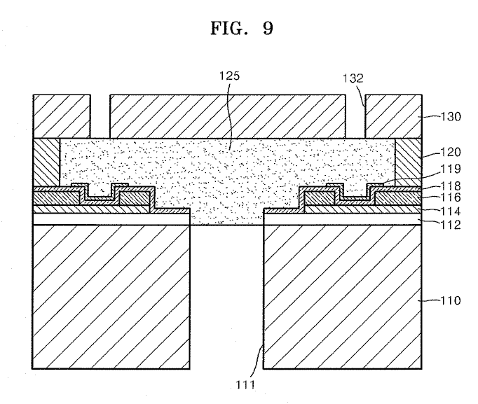

Referring to FIG. 9, a bottom surface of the substrate 110 is etched to form an ink feed hole 111 to supply ink. The ink feed hole 111 may be formed by etching the bottom surface of the substrate 110 until a bottom surface of the sacrificial layer 125 which fills the trench 113 (refer to FIG. 6) is exposed. Finally, referring to FIG. 10, the sacrificial layer 125 filled in the trench 113, the ink chambers 122, and the restrictors 124 is removed to complete a thermal inkjet printhead. The sacrificial layer 125 can be removed by injecting an etchant to selectively etch and remove only the sacrificial layer 125 into the nozzles 132 and the ink feed hole 111. As a result of the removal of the sacrificial layer 125, the ink chambers 122 and the restrictors 124 connecting the ink chambers 122 and the ink feed hole 111 are formed in the chamber layer 120. As described above, since the chamber layer 120 and the sacrificial layer 125 can be uniformly formed to a desired height by the primary CMP process, or the combined primary and secondary CMP processes, the ink chambers 122 can also be uniformly formed to be a desired height after the sacrificial layer 125 is removed.

As is apparent from the above description, according to the present general inventive concept, in a CMP process to planarize top surfaces of a chamber layer 120 and a sacrificial layer 125, by adjusting the size and material of polishing particles included in a slurry 175 and/or a material and a pressurization force of a polishing pad 151, etc., a dishing phenomenon caused in a conventional CMP process can be minimized, thus making the heights of the chamber layer 120 and the sacrificial layer 125 uniform. Thus, it is possible to form ink chambers 122 to a desired uniform height, thereby enhancing the ink ejection characteristics of an inkjet printhead. Moreover, by using an additional CMP process, a scratch formed on a surface of the sacrificial layer 125 can be removed and the degree of planarity of the chamber layer 120 and the sacrificial layer 125 can be further enhanced.

FIG. 13 is an image that illustrates a profile of an inkjet printhead manufactured using a method according to an embodiment of the present general inventive concept having a nozzle 132 formed above ink chamber 122.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of manufacturing a thermal inkjet printhead, comprising:
forming on a substrate a chamber layer having an ink chamber;
forming a sacrificial layer on the chamber layer such that the sacrificial layer fills the ink chamber; and
planarizing a top surface of the sacrificial layer and a top surface of the chamber layer using a primary Chemical Mechanical Polishing (CMP) process until the sacrificial layer and the chamber layer attain a desired height,
wherein a slurry is used in the primary CMP process and includes polishing particles having an average particle size of 500 nm˜2 μm.

2. The method of claim 1, wherein the polishing particles are made of silica or alumina.

3. The method of claim 2, wherein the polishing particles have a pH of 2.5-11.

4. The method of claim 1, wherein a polishing pad is used in the primary CMP process and is rotated while exerting a pressure of 5˜45 kPa to a top surface of the sacrificial layer.

5. The method of claim 4, wherein a surface hardness of the polishing pad is 70 or less, as measured in Shore D hardness.

6. The method of claim 1, wherein the chamber layer is formed of a material having a greater hardness than the sacrificial layer.

7. The method of claim 6, wherein the chamber layer and the sacrificial layer are formed, respectively, of a photosensitive epoxy resin and a photoresist material.

8. The method of claim 7, wherein in the formation of the chamber layer, the photosensitive epoxy resin is coated on the substrate using a spin coating process and a pattern is then formed thereon using a photolithography process.

9. The method of claim 7, wherein in the formation of the sacrificial layer, the photoresist material is coated on the chamber layer using a spin coating process.

10. The method of claim 1, further comprising planarizing the top surface of the chamber layer and of the sacrificial layer using a secondary CMP process, after performing the primary CMP process.

11. The method of claim 10, wherein the slurry used in the secondary CMP process includes polishing particles having an average particle size of 50˜500 nm.

12. The method of claim 11, wherein the polishing particles are made of silica or alumina.

13. The method of claim 12, wherein the polishing particles have a pH of 2.5˜11.

14. A method of manufacturing a thermal inkjet printhead, the method comprising:
forming an insulating layer on a substrate;
sequentially forming on the insulating layer, a heater to heat ink and an electrode to apply current to the heater;
forming on the insulating layer a chamber layer having an ink chamber;
forming in the insulating layer a trench through which the substrate is exposed;
forming a sacrificial layer on the chamber layer such that the sacrificial layer fills the ink chamber and the trench;
planarizing a top surface of the sacrificial layer and of the chamber layer using a primary CMP process until the sacrificial layer and the chamber layer attain a desired height;
forming on the planarized sacrificial layer and chamber layer a nozzle layer having a nozzle;
etching a bottom surface of the substrate to form an ink feed hole to connect with the trench; and
removing the sacrificial layer,
wherein a is slurry used in the primary CMP process which includes polishing particles having an average particle size of 500 nm˜2 μm.

15. The method of claim 14, wherein the polishing particles are made of silica or alumina.

16. The method of claim 15, wherein a polishing pad is used in the primary CMP process and is rotated while exerting a pressure of 5˜45 kPa to a top surface of the sacrificial layer.

17. The method of claim 14, wherein the chamber layer is formed of a material having a greater hardness than the sacrificial layer.

18. The method of claim 14, wherein the slurry used in the secondary CMP process includes polishing particles having an average particle size of 50˜500 nm.

19. The method of claim 14, further comprising forming a passivation layer on the insulating layer to cover the heater and the electrode, after forming the heater and the electrode.

20. The method of claim 14, wherein in the formation of the nozzle layer, a photosensitive epoxy resin is coated on the top surfaces of the sacrificial layer and the chamber layer and a pattern is then formed thereon using a photolithography process.
